(19) United States
(12) Patent Application Publication
(10) Pub. No.: US 2002/0161573 A1
(43) Pub. Date: Oct. 31, 2002

(54) Speech coding/decoding appatus and method

(76) Inventor: Koji Yoshida, Yokohama-shi (JP)

Correspondence Address: Stevens Davis Miller & Mosher, Suite 850, 1615 L Street NW, Washington, DC, 20036, US

(21) Appl. No.: 09/959,533

(22) PCT Filed: Feb. 16, 2001
(86) PCT No.: PCT/JP01/01110

(30) Foreign Application Priority Data
Feb. 29, 2000 (JP) 2000-54108

(51) Int. Cl. G10L 19/00; G10L 21/00

(52) U.S. Cl. 704/201

(57) ABSTRACT

Demultiplexing/DTX controller 301 receives as received data transmission data that the coding side has transmitted after coding the input signal, and demultiplexes the received data into speech coded data or noise coded data necessary for speech decoding or noise generation and a voiced/non-voice determination flag. When the voiced/non-voice determination flag is indicative of a voiced region, speech decoder 302 performs speech decoding on the speech coded data to output a decoded speech. Noise signal generator 303 generates a noise signal from the noise coded data, and outputs the noise signal. Speech/noise signal adder 304 outputs the generated noise signal output from noise generator 303 as a decoded signal during an interval of the non-voice region, while during an interval of the voiced region, adding the decoded speech signal output from speech decoder 302 and the generated noise signal output from noise signal generator 303 to output as a decoded signal.

### TECHNICAL FIELD

The present invention relates to a low bit rate speech coding apparatus used in a mobile communication system for coding a speech signal to transmit and speech recording apparatus.

### BACKGROUND ART

In the fields of digital mobile communications and speech storage are used speech coding apparatuses which encode speech signals at a low bit rate for efficient utilization of radio frequency and recording media. In particular, with respect to speech signals, a speech signal of a voiced region is coded to be transmitted, while a speech signal of a non-voice region is coded and transmitted at a lower bit rate than that in the voiced region using a noise signal coder dedicated to the non-voice region. It is thereby possible to further decrease the bit rate used in transmission.

As a conventional technique for coding the speech signal at such low bit rates, there is a CS-ACELP (Conjugate-Structure Algebraic-Code-Excited Liner-Prediction) coding system with DTX (Discontinuous Transmission) control specified in ITU-T Recommendation G.729 Annex B (“A silence compression scheme for G.729 optimized for terminals conforming to Recommendation V.70”).

FIG. 1 illustrates a configuration of a coding apparatus in the CS-ACELP coding system with DTX control as the conventional technique. In this coding apparatus, voiced/non-voice determiner 1 determines whether an input signal is of a voiced region or non-voice region (region with only a background noise).

When voiced/non-voice determiner 1 determines that the input signal is of a voiced region, CS-ACELP speech coder 2 performs speech coding of voiced region on the input signal. Meanwhile, when voiced/non-voice determiner 1 determines that the input signal is of a non-voice region, non-voice-region coder 3 performs coding of background noise of non-voice region on the input signal.

Non-voice-region coder 3 calculates LPC coefficients and LPC prediction residual energy of the input signal from the input signal in the same way as that in the coding of voiced region, and outputs the calculations as coded data of non-voice region to DTX control/multiplexer 4.

Using outputs of voiced/non-voice determiner 1, CS-AcELP speech coder 2 and non-voice-region coder 3, DTX control/multiplexer 4 controls data to be transmitted as transmission data, and multiplexes the data as transmission data.

FIG. 2 illustrates a configuration of a conventional decoding apparatus. In the decoding apparatus, demultiplex/DTX controller 11 receives as received data the transmission data that the coding side has transmitted after coding the input signal, and demultiplexes the received data into speech coded data or noise coded data necessary for speech decoding and noise generation, and a voiced/non-voice determination flag.

When the voiced/non-voice determination flag is indicative of a voiced region, CS-ACELP speech decoder 12 performs the speech decoding on the speech coded data, and outputs the decoded speech to output switch 14. Meanwhile, when the voiced/non-voice determination flag is indicative of a non-voice region, noise signal regenerator 13 generates a noise signal from the noise coded data, and outputs the noise signal to output switch 14.

Output switch 14 switches between the output of speech decoder 12 and the output of noise signal generator 13 corresponding to the result of the voiced/non-voice determination flag to output as an output signal. In other words, the output of speech decoder 12 becomes the output signal in a voiced region, while the output of noise signal generator 13 becomes the output signal in a non-voice region.

In the above-mentioned conventional speech coding apparatus, the CS-ACELP speech coder performs coding only on the voiced region, while the dedicated non-voice-region coder performs coding on the non-voice region (region with only a noise) at a bit rate lower than that of the speech coder, whereby the average transmit bit rate is reduced.

However, when a speech signal with a surrounding background noise added thereon is input as an input signal, the quality of the decoded speech deteriorates during an interval of a voiced region due to the effect of the multiplexed background noise. Further, since a noise is generated using data coded by the different method from that in a voiced region during an interval of a non-voice region, unnaturalness arises due to a difference of perceptual quality between a background noise in the decoded speech during an interval of the voiced region and a background noise generated during an interval of the non-voice region. These tendencies become remarkable particularity at a low bit rate such as a coding bit rate less than or equal to 8 kbit/s.

### DISCLOSURE OF INVENTION

It is an object of the present invention to provide a speech coding apparatus and decoding apparatus that enable less quality deterioration of a decoded signal for a speech signal with a background noise added thereon.

It is a subject matter of the present invention that a noise signal is generated in a voiced region as well as in a non-voice region, the noise signal is added to the decoded speech signal in the voiced region to be output, and that the quality deterioration of the decoded signal is thereby reduced on the speech signal with a background noise added thereon.

### BRIEF DESCRIPTION OF DRAWINGS

FIG. 1 is a block diagram illustrating a configuration of a conventional speech coding apparatus;

FIG. 2 is a block diagram illustrating a configuration of a conventional speech decoding apparatus;

FIG. 3 is a block diagram illustrating a configuration of a radio communication apparatus provided with a speech coding/decoding apparatus according to a first embodiment of the present invention;

FIG. 4 is a block diagram illustrating a configuration of a speech coding apparatus according to the first embodiment of the present invention;

FIG. 5 is a block diagram illustrating a configuration of a speech decoding apparatus according to the first embodiment of the present invention;

FIG. 6 is a flowchart indicative of a processing flow of a speech coding method according to the first embodiment of the present invention;

FIG. 7 is a flowchart indicative of a processing flow of a speech decoding method according to the first embodiment of the present invention;

FIG. 8A is a diagram illustrating an example of an output signal in schematic form obtained in the conventional speech decoding apparatus;

FIG. 8B is a diagram illustrating an example of an output signal in schematic form obtained in the speech decoding apparatus of the present invention; and

FIG. 9 is a block diagram illustrating a configuration of a speech/noise signal adder in the speech decoding apparatus according to a second embodiment of the present invention.

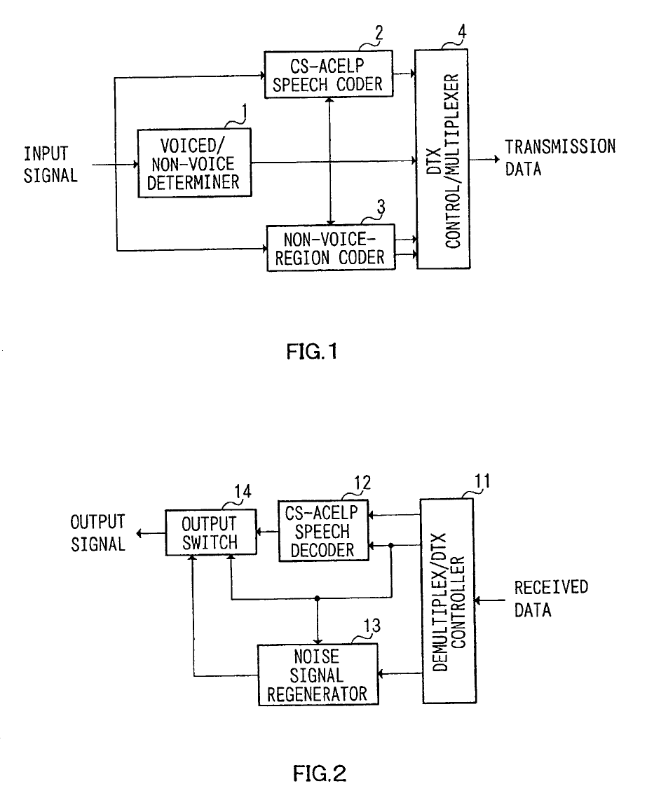

Best Mode for Carrying Out the Invention

Embodiments of the present invention will be described specifically below with reference to accompanying drawings.

(First Embodiment)

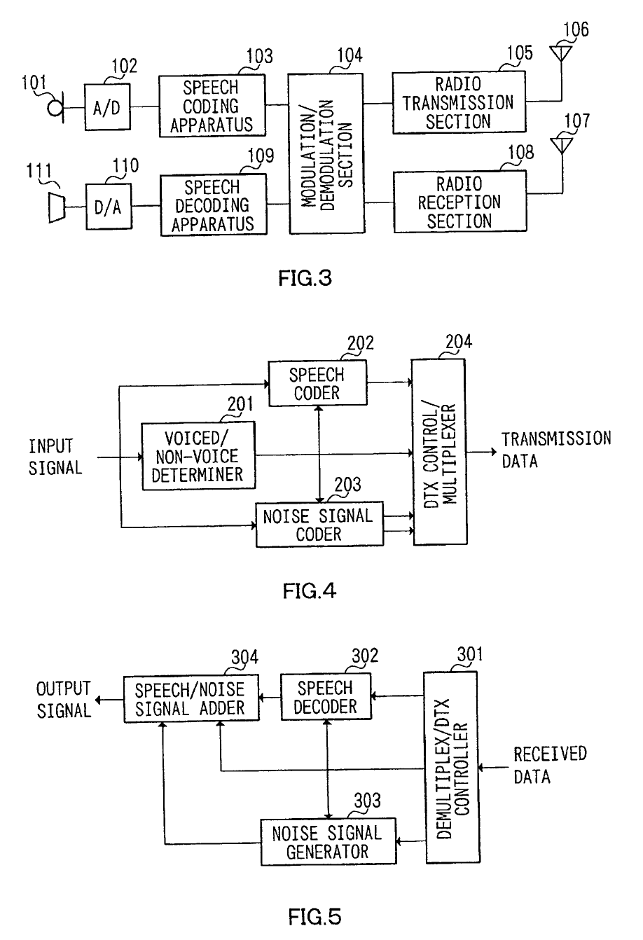

FIG. 3 is a block diagram illustrating a configuration of a radio communication apparatus provided with a speech coding/decoding apparatus according to the first embodiment of the present invention. In the radio communication apparatus, on the transmission side, a speech is converted into an electric analog signal in speech input apparatus 101 such as a microphone to be output to A/D converter 102. The analog speech signal is converted into a digital signal in A/D converter 102 to be output to speech coding apparatus 103.

Speech coding apparatus 103 performs speech coding on the digital speech signal, and outputs the coded information to modulation/demodulation section 104. Modulation/demodulation section 104 performs digital modulation on the coded speech signal to provide to radio transmission section 105. Radio transmission section 105 performs the predetermined radio transmission processing on the modulated signal. The processed signal is transmitted through antenna 106.

Meanwhile, on the reception side of the radio communication apparatus, a received signal received in antenna 107 is subjected to the predetermined reception processing in radio reception section 108 to be provided to modulation/demodulation section 104. Modulation/demodulation section 104 demodulates the received signal, and outputs the demodulated signal to speech decoding apparatus 109. Speech decoding apparatus 109 performs speech decoding on the demodulated signal, thereby obtains a digital decoded speech signal, and outputs the digital decoded speech signal to D/A converter 110.

D/A converter 110 converts the digital decoded speech signal output from speech decoding apparatus 109 into an analog speech signal to output to speech output apparatus 111 such as a speaker. Finally, speech output apparatus 111 outputs an electric analog speech signal as a speech.

Speech coding apparatus 103 illustrated in FIG. 3 has a configuration as illustrated in FIG. 4. FIG. 4 is a block diagram illustrating the configuration of the speech coding apparatus according to the first embodiment of the present invention. Voiced/non-voice determiner 201 determines whether an input speech signal is of a voiced region or of a non-voice region (region with only a noise), and outputs the determination result (region determination information) to DTX control/multiplexer 204.

As voiced/non-voice determiner 201, an arbitrary determiner may be used. Generally, the determination is performed using instantaneous value or amount of change of a plurality of parameters such as power, spectra, and pitch period of an input signal.

When the determination result in voiced/non-voice determiner 201 is indicative of a voiced region, speech coder 202 performs the speech coding on the input speech signal, and outputs the coded data to DTX control/multiplexer 204. Speech coder 202 is a coder for voiced region, and may be an arbitrary coder for coding a speech with high efficiency.

Meanwhile, when the determination result in voiced/non-voice determiner 201 is indicative of a non-voice region, noise signal coder 203 performs the coding of noise signal on the input signal in the non-voice region containing only a noise signal, and outputs the noise coded data to DTX control/multiplexer 204. As noise signal coder 203, an arbitrary coder may be used. Generally, coding is performed on information (for example, LPC parameters) indicative of a spectrum of a noise signal and information indicative of power of the signal.

Finally, DTX control/multiplexer 204 controls information to be transmitted as transmission data and multiplexes the transmit information using outputs from voiced/non-voice determiner 201, speech coder 202 and noise signal coder 203 to output as transmission data.

A configuration of speech decoding apparatus 109 will be described below. Speech decoding apparatus 109 illustrated in FIG. 3 has a configuration as illustrated in FIG. 5. Demultiplexing/DTX controller 301 receives as received data the transmission data that the coding side has transmitted after coding the input signal, and demultiplexes the received data into speech coded data or noise coded data necessary for speech decoding or noise generation and a voiced/non-voice determination flag.

When the voiced/non-voice determination flag is indicative of a voiced region, speech decoder 302 performs the speech decoding on the speech coded data to output a decoded speech. Meanwhile, noise signal generator 303 generates a noise signal from the noise coded data, and outputs the noise signal. For example, when the coding side represents a noise signal by the spectrum and power, performs coding on the spectrum with LPC parameters and further performs coding on the power with power of the LPC residual signal, the noise generation is achieved by LPC synthesis using decoded LPC parameters to a random excitation with the power of the LPC residual signal decoded on the decoding side.

In addition, it may be possible that by the DTX control, noise coded data is received at predetermined intervals or when necessary during an interval of a non-voice region to generate a noise, while during an interval when no data is received, the noise signal is output which is generated using the noise coded data previously received.

Speech/noise signal adder 304 outputs the generated noise signal output from noise signal generator 303 as a decoded signal during an interval of the non-voice region, while during an interval of the voiced region, adding the decoded speech signal output from speech decoder 302 and the generated noise signal output from noise signal generator 303 to output as a decoded signal.

The operations of the speech coding section and speech decoding section with the above configuration will be described below.

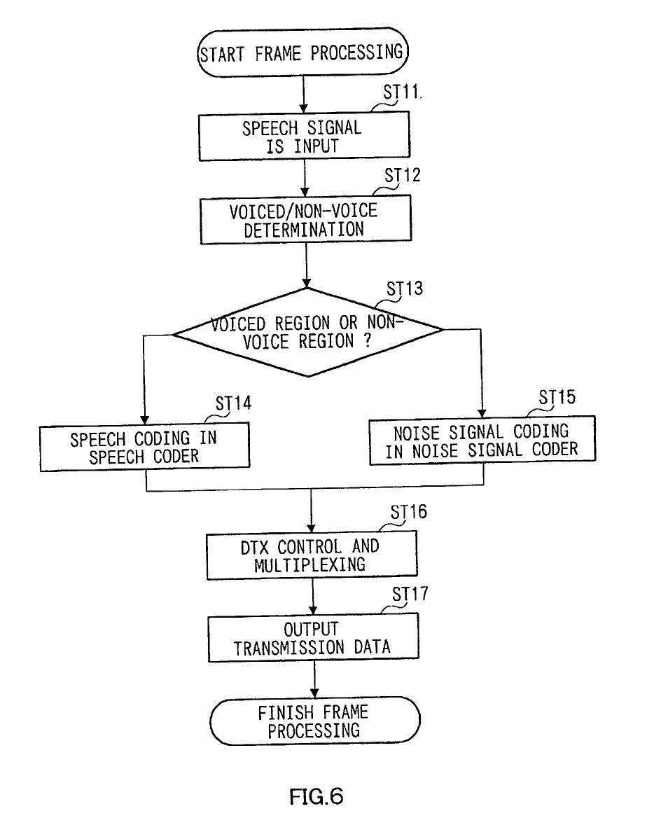

FIG. 6 is a flowchart illustrating a processing flow of the speech coding method according to the first embodiment. In addition, it is assumed to perform the processing illustrated in FIG. 6 repeatedly for each frame with a predetermined short region (for example, about 10 ms to 50 ms).

In step (hereinafter abbreviated as ST) 11, an input signal is input per frame basis. In ST12, the input signal undergoes the voiced/non-voice region determination (ST13), and the determination result is output. When the determination result is indicative of a voiced region, the input speech signal undergoes the speech coding and the coded data is output (ST14).

Meanwhile, when the determination result in ST 13 is indicative of a non-voice region, the noise signal coder performs the noise signal coding on the input signal and outputs the noise coded data representative of the input noise signal in ST15.

In ST16, the information to be transmitted as transmission data is controlled and the transmission information is multiplexed, using outputs obtained from the results of the voiced/non-voice determination, speech coding and noise signal coding. Finally, in ST17 the transmission data is output.

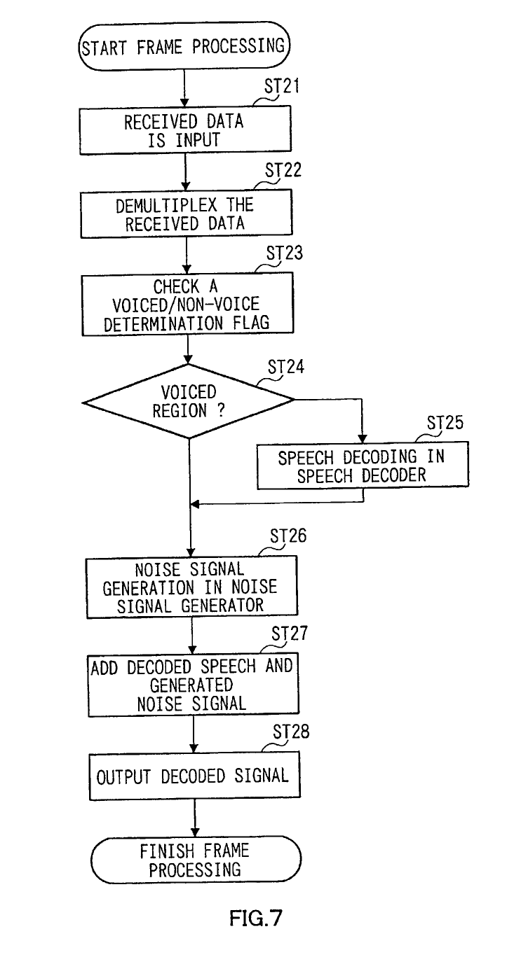

FIG. 7 is a flowchart illustrating a processing flow of the speech decoding method according to the first embodiment. In addition, it is assumed to perform the processing illustrated in FIG. 7 repeatedly for each frame with a predetermined short region (for example, about 10 ms to 50 ms).

In ST21, transmission data is input which the coding side has transmitted after coding an input signal. In ST22, the transmission data is demultiplexed into speech coded data or noise coded data necessary for speech decoding and noise generation, and a voiced/non-voice determination flag.

In ST23, the voiced/non-voice determination result by the voiced/non-voice determination flag is checked (ST24). When the voiced/non-voice determination flag is indicative of a voiced region, in ST25 the speech decoding is performed on the speech coded data to output a decoded speech. Next in ST26, a noise signal is generated from the noise coded data to be output.

In ST27, the decoded speech signal output in ST25 and the generated noise signal output in ST26 are added. In addition, during an interval of a non-voice region, the decoded speech signal is not added, and only the generated noise signal is output. Finally in ST28, the finally obtained output signal is output as an output of the decoder.

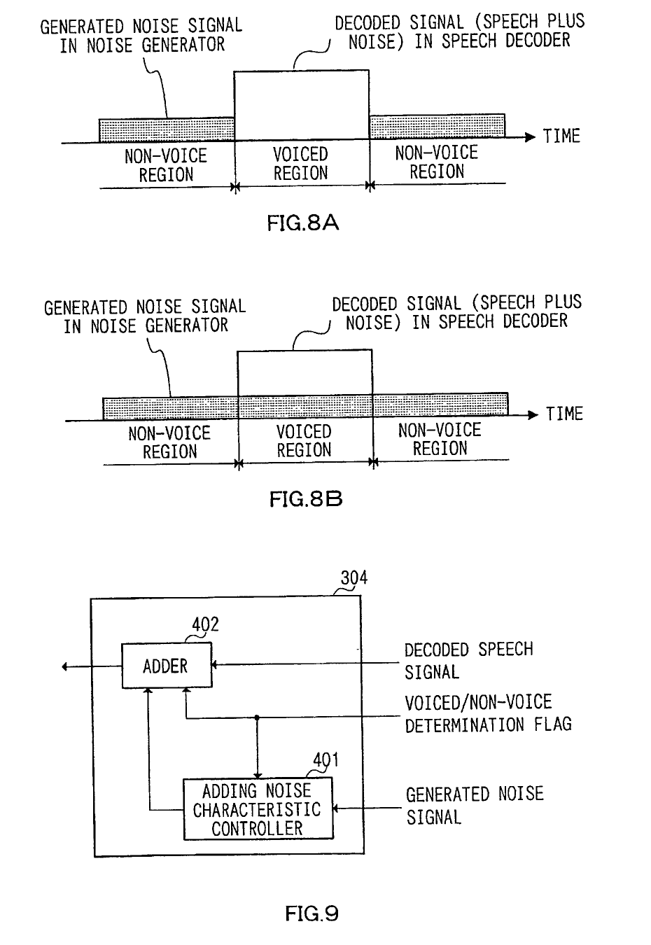

FIG. 8 shows examples of output signals in schematic form obtained in the conventional speech decoding apparatus and in the speech decoding apparatus of the present invention when a speech signal with a background noise added thereon is input.

In the conventional speech decoding apparatus, as illustrated in FIG. 8A, during an interval of a voiced region, the perceptual quality deteriorates due to a distortion of a decoded speech caused by decoding a speech signal with a background noise added thereon, and unnaturalness is left due to the difference of perceptual quality between the background noise in the decoded speech during an interval of the voiced region and the background noise generated during an interval of the non-voice region by the different method from that in the voiced region.

In contrast thereto, in the speech decoding apparatus of the present invention, as illustrated in FIG. 8B, the generated noise signal generated by the noise signal generator is added to the decoded speech signal to be output during an interval of a voiced region as well as during an interval of a non-voice region, whereby the quality deterioration due to the background noise of the voiced region is masked and therefore the effect of the deterioration is reduced, and the feeling of unnatural is reduced due to the fact that the perceptual quality of the background noise in the decoded speech during an interval of the voiced region becomes similar to the perceptual quality of the background noise generated during an interval of the non-voice region.

Thus, according to the speech coding/decoding apparatus and speech coding/decoding method according to this embodiment, the noise signal generator generates a noise signal in a voiced region as well as in a non-voice region, and the speech/noise signal adder adds the generated noise signal to the decoded speech signal in the voiced internal to output, whereby also with respect to the speech signal with a background noise added thereon, the added generated noise signal masks the quality deterioration due to the background noise in the voiced region, and thereby reduces the effect of the deterioration. Further, due to the fact that the perceptual quality of the background noise in the decoded speech during an interval of the voiced region becomes similar to the perceptual quality of the background noise generated during an interval of the non-voice region, the feeling of unnatural is reduced and it is possible to perform the speech decoding with improved speech quality.

(Second Embodiment)

FIG. 9 is a block diagram illustrating a configuration of a speech/noise signal adder in a speech decoding apparatus according to the second embodiment of the present invention. In addition, the entire configuration and the operation of the speech decoding apparatus according to the second embodiment of the present invention are the same as those in the first embodiment except the speech/noise signal adder, and therefore, with descriptions thereof are omitted, the operation of the speech/noise signal adder will be only described with reference to FIG. 9.

In FIG.9, added noise characteristic controller 401 adaptively controls the characteristic of a noise to be added during an interval of the voiced region corresponding to the characteristic of the generated noise signal. The characteristic-controlled generated noise signal is output to adder 402, and is added to the decoded speech signal that is separately input to adder 402. The resultant signal is output as a decoded output signal. In this case, adding noise characteristic controller 401 switches the noise signal to be added according to the voiced/non-voice determination flag to output to adder 402. It is thereby possible to adaptively switch noise signals to be added to the voiced region and to be added to the non-voice region, whereby it is possible to obtain decoded speech with more perceptually improved speech qualitiy.

One example of specific controls performed by adding noise characteristic controller 401 is as follows; when the generated noise signal input to the controller 401 has a non-stationary characteristic, the controller 401 suppresses a level of the input generated noise signal, and outputs the generated noise signal suppressed in level to adder 402.

The non-stationarity of the generated noise signal is capable of being determined, for example, by analyzing a variation in spectrum and power of received noise coded data or generated noise signal. When the variation is great, the characteristic is determined to be the non-stationarity. Further, it may be possible for a coding side to transmit coded information indicative of the signal characteristic (for example, stationarity/non-stationarity) obtained by analyzing an input signal in the noise signal coding during an interval of the non-voice region. Furthermore, it may be possible for adding noise characteristic controller 401 to control other characteristics (such as spectral form) as well as a level of the generated noise to be added.

Thus, according to the speech decoding apparatus according to this embodiment, the characteristic of the generated noise to be added during an interval of a voiced region is controlled corresponding to the characteristic of the background noise added on the input signal, whereby it is possible to perform decoding with more perceptually improved speech quality. Specifically, as an example, when the characteristic of the noise signal of a non-voice region is determined to be non-stationary, a level of the generated noise signal to be added during an interval of a voiced region is decreased, and it is thereby possible to reduce an unnecessary feeling of unnatural caused by adding the generated noise during an interval of the voiced region.

The present invention is applicable to a radio base station apparatus and communication terminal apparatus in a digital radio communication system. It is thereby possible to transmit and receive perceptually improved speech signals.

The present invention is not limited to the above first and second embodiments, and is capable of being carried into practice with various modifications thereof. While the speech coding/decoding apparatus according to the first or second embodiment is described as a speech coding/decoding apparatus, While the speech coding/decoding according to the first or second embodiment is achieved by speech coding/decoding apparatus, the speech coding/decoding may be constructed by software. For example, it may be possible to store a program of the above speech coding/decoding in a ROM, and to operate by instruction of CPU according to the program. Further, it may be possible to store the speech coding/decoding program in a computer readable storage medium, to record the speech coding/decoding program of the storage medium in a RAM of a computer, and to operate according to the program. Such cases also exhibit the same function and effect as in the first and second embodiment.

A speech decoding apparatus of the present invention has a configuration provided with a receiving section that receives a signal including speech coded data and noise coded data each coded on a coding side and region determination information, a speech decoding section that decodes the speech coded data when the region determination information is indicative of a voiced region, a noise signal generating section that generates a noise signal from the noise coded data, and a noise signal adding section that adds the noise signal to the decoded speech signal decoded in the speech decoding section in the voiced region.

According to this configuration, the noise signal generating section generates a noise signal in a voiced region as well as in a non-voice region, and the noise signal adding section adds the generated noise signal to the decoded speech signal in the voiced region to output, whereby also with respect to the speech signal with a background noise added thereon, the added generated noise signal masks the quality deterioration due to the background noise in the voiced region, and thereby reduces the effect of the deterioration. Further, due to the fact that the perceptual quality of the background noise in the decoded speech during an interval of the voiced region becomes similar to the perceptual quality of the background noise generated during an interval of the non-voice region, unnaturalness is reduced and it is possible to perform decoding with improved speech quality.

In the speech decoding apparatus of the present invention with the above configuration, the noise signal adding section adaptively controls a characteristic of the noise signal to be added during an interval of the voiced region based on the characteristic of the noise coded data or the noise signal.

According to this constitution, the characteristic of a generated noise to be added during an interval of the voiced region is adaptively controlled corresponding to the characteristic of a background noise added on the input signal, whereby it is possible to perform decoding with more perceptually improved speech quality.

In the speech decoding apparatus of the present invention with the above configuration, the noise signal adding section decreases a level of the noise signal to be added during an interval of the voiced region when the region determination information is indicative of a non-voice region and the characteristic of the noise signal is non-stationary.

According to this constitution, it is possible to reduce an excessive noisiness caused by adding the generated noise during an interval of the voiced region.

A speech coding/decoding apparatus of the present invention has a configuration provided with a speech coding apparatus having a region determining section that determines whether an input speech signal is of a voiced region or of a non-voice region, a speech coding section that performs speech coding on the input speech signal when a determination result in the region determining section is indicative of a voiced region, and a noise signal coding section that performs noise-signal coding on the input speech signal when a result determined in the region determining section is indicative of a non-voice region, and a speech decoding apparatus with the above configuration.

According to this configuration, it is possible to perform coding and decoding on a speech signal with a background noise added thereon also with quality deterioration on the decoded signal suppressed.

A base station apparatus of the present invention is characterized by having the speech decoding apparatus with the above configuration or the speech coding/decoding apparatus with the above configuration. Further, a communication terminal apparatus of the present invention is characterized by having the speech decoding apparatus with the above configuration or the speech coding/decoding apparatus with the above configuration. According to these configurations, it is made possible to transmit and receive perceptually improved speech signals.

A speech decoding method of the present invention has a receiving step of receiving a signal including speech coded data and noise coded data each coded on a coding side and region determination information, a speech decoding step of decoding the speech coded data when the region determination information is indicative of a voiced region, a noise signal generating step of generating a noise signal from the noise coded data, and a noise signal adding step of adding the noise signal to the decoded speech signal decoded in the speech decoding step in the voiced region.

According to this method, in the noise signal generating step a noise signal is generated in a voiced region as well as in a non-voice region, and in the noise signal adding step the generated noise signal is added to the decoded speech signal in the voiced region to be output, whereby also with respect to the speech signal with a background noise added thereon, the added generated noise signal masks the quality deterioration due to the background noise in the voiced region, and thereby reduces the effect of the deterioration. Further, due to the fact that the perceptual quality of the background noise in the decoded speech during an interval of the voiced region becomes similar to the perceptual quality of the background noise generated during an interval of the non-voice region, unnaturalness is reduced and it is possible to perform decoding with improved speech quality.

In the speech decoding method of the present invention with the above steps, in the noise signal adding step a characteristic of the noise signal to be added during an interval of the voiced region is adaptively controlled based on the characteristic of the noise coded data or the noise signal.

According to this method, the characteristic of a generated noise to be added during an interval of the voiced region is adaptively controlled corresponding to the characteristic of a background noise added on the input signal, whereby it is possible to perform decoding with more perceptually improved speech quality.

In the speech decoding method of the present invention with the above steps, in the noise signal adding step a level of the noise signal added during an interval of the voiced region is decreased when the region determination information is indicative of a non-voice region and the characteristic of the noise signal is non-stationary.

According to this method, it is possible to reduce an unnecessary feeling of noise caused by adding the generated noise during an interval of the voiced region.

A speech decoding method of the present invention is characterized by adding a noise signal added in coding to the voiced region. The added generated noise signal masks the quality deterioration due to the background noise in the voiced region, and thereby reduces the effect of the deterioration.

A speech coding/decoding method of the present invention has a speech coding step of determining whether an input speech signal is of a voiced region or of a non-voice region, performing speech coding on the input speech signal when a determination result is indicative of a voiced region, and performing noise-signal coding on the input speech signal when a determination result is indicative of a non-voice region, and the above speech decoding step.

According to this method, it is possible to perform coding and decoding on a speech signal with a background noise added thereon also with quality deterioration on the decoded signal suppressed.

A computer readable storage medium of the present invention stores a speech decoding program which has procedures of decoding speech coded date when region determination result of a signal including speech coded data and noise coded data each coded on a coding side and the region determination information is indicative of a voiced region, generating a noise signal from the noise coded data, and adding the noise signal to a decoded speech signal decoded in the speech decoded procedure in the voiced region.

As described above, in the speech coding/decoding apparatus of the present invention, the noise signal generator generates a noise signal in a voiced region as well as in a non-voice region, and the speech/noise signal adder adds the generated noise signal to the decoded speech signal in the voiced region to output. Therefore, also with respect to the speech signal with a background noise added thereon, the added generated noise signal masks the quality deterioration due to the background noise in the voiced region, and thereby reduces the effect of the deterioration. Further, due to the fact that the perceptual quality of the background noise in the decoded speech during an interval of the voiced region becomes similar to the perceptual quality of the background noise generated during an interval of the non-voice region, unnaturalness is reduced and it is possible to perform decoding with improved speech quality.

Further in the speech coding/decoding apparatus of the present invention, the characteristic of a generated noise to be added during an interval of the voiced region is adaptively controlled corresponding to the characteristic of a background noise added on the input signal. It is thereby possible to perform decoding with more perceptually improved speech quality. Specifically, as an example, when the characteristic of the noise signal of a non-voice region is determined to be non-stationary, a level of the generated noise signal to be added during an interval of a voiced region is decreased, and it is thereby possible to reduce an unnecessary feeling of noise caused by adding the generated noise during an interval of the voiced region.

This application is based on the Japanese Patent Application No.HEI2000-054108 filed on Feb. 29, 2000, entire content of which is expressly incorporated by reference herein.

### INDUSTRIAL APPLICABILITY

The present invention is applicable to a low bit rate speech coding apparatus used in a mobile communication system for coding a speech signal to transmit and speech recording apparatus.

1. A speech decoding apparatus comprising:
receiving means for receiving a signal including speech coded data and noise coded data each coded on a coding side and region determination information;
speech decoding means for decoding the speech coded data when the region determination information is indicative of a voiced region;
noise signal generating means for generating a noise signal from the noise coded data; and
noise signal adding means for adding the noise signal to the decoded speech signal decoded in said speech decoding means in the voiced region.

2. The speech decoding apparatus according to claim 1, wherein said noise signal adding means adaptively controls a characteristic of the noise signal to be added during an interval of the voiced region based on the characteristic of the noise coded data or the noise signal.

3. The speech decoding apparatus according to claim 2, wherein said noise signal adding means decreases a level of the noise signal to be added during an interval of the voiced region when the region determination information is indicative of a non-voice region and the characteristic of the noise signal is non-stationary.

4. A speech coding/decoding apparatus comprising:
a speech coding apparatus having region determining means for determining whether an input speech signal is of a voiced region or of a non-voice region, speech coding means for performing speech coding on the input speech signal when a determination result in said region determining means is indicative of a voiced region, and noise signal coding means for performing noise-signal coding on the input speech signal when a determination result in said region determining means is indicative of a non-voice region; and
the speech decoding apparatus according to claim 1.

5. A speech coding apparatus comprising:
region determining means for determining whether an input speech signal is of a voiced region or of a non-voice region;
speech coding means for performing speech coding on the input speech signal when a determination result in said region determining means is indicative of a voiced region; and
noise signal coding means for performing noise-signal coding on the input speech signal when a determination result in said region determining means is indicative of a non-voice region.

6. A speech decoding method of comprising:
a receiving step of receiving a signal including speech coded data and noise coded data each coded on a coding side and region determination information;
a speech decoding step of performing decoding the speech coded data when the region determination information is indicative of a voiced region;
a noise signal generating step of generating a noise signal from the noise coded data; and
a noise signal adding step of adding the noise signal to the decoded speech signal decoded in said speech decoding step in the voiced region.

7. The speech decoding method according to claim 6, wherein in said noise signal adding step a characteristic of the noise signal to be added during an interval of the voiced region is adaptively controlled based on the characteristic of the noise coded data or the noise signal.

8. The speech decoding method according to claim 7, wherein in said noise signal adding step a level of the noise signal to be added during an interval of the voiced region is decreased when the region determination information is indicative of a non-voice region and the characteristic of the noise signal is non-stationary.

9. The speech decoding method according to claim 6, wherein a noise signal added in coding is added to the voiced region.

10. A speech coding/decoding method comprising:
a speech coding step of determining whether an input speech signal is of a voiced region or of a non-voice region, performing speech coding on the input speech signal when a determination result is indicative of a voiced region, and performing noise-signal coding on the input speech signal when a determination result is indicative of a non-voice region; and
the speech decoding step according to claim 6.

11. A computer readable storage medium storing a speech decoding program, said speech decoding program having the procedures of:
decoding speech coded date when region determination result of a signal including the speech coded data and noise coded data each coded on a coding side and the region determination information is indicative of a voiced region;
generating a noise signal from the noise coded data; and
adding the noise signal to the decoded speech signal in the voiced region.

12. A speech decoding program for use in operating a computer, having the functions of:
decoding speech coded date when region determination result of a signal including the speech coded data and noise coded data each coded on a coding side and the region determination information is indicative of a voiced region;
generating a noise signal from the noise coded data; and
adding the noise signal to the decoded speech signal in the voiced region.
